(19) United States
(12) Patent Application Publication
(10) Pub. No.: US 2026/0195207 A1
(43) Pub. Date: Jul. 9, 2026

(54) ROOT CAUSE ANALYSIS FOR ANOMALY JOBS

(71) Applicant: Microsoft Technology Licensing, LLC, Redmond, WA (US)

(72) Inventors: Yiwen ZHU, San Francisco, CA (US); Manting LI, Beijing (CN); Zhen LI, Beijing (CN); Subramaniam VENKATRAMAN KRISHNAN, Barcelona (ES); Xiaolei LIU, Beijing (CN); Long TIAN, Beijing (CN); Lie JIANG, Beijing (CN); Kun HUANG, Beijing (CN); Lijing LIN, Beijing (CN); Fathelrahman Ahmed Elmisbah ALI, Palo Alto, CA (US)

(21) Appl. No.: 19/011,868

(22) Filed: Jan. 7, 2025

(51) Int. Cl. G06F 11/07

(52) U.S. Cl. CPC G06F 11/079; G06F 11/0709

(57) ABSTRACT

A system accesses metrics of features of workflows indicating an anomaly, the features represented as nodes in a graph and causal relationships as links, wherein a root node corresponds to the anomaly. The system, for each feature in each subgraph, computes an adjacent contribution score corresponding to each link for which the feature is a causing node, based on the metrics. The system determines a nonadjacent contribution score for each feature of the nodes in the graph to the anomaly by: assigning the adjacent contribution scores of features in a root subgraph of the multiple subgraphs that includes the root node to the corresponding features in the graph, for an adjacent subgraph of the multiple subgraphs that includes a shared feature that is also in the root subgraph, modifying the adjacent contribution scores of unique features of the adjacent subgraph based on the nonadjacent contribution score of the shared feature.

### BACKGROUND

In the field of data processing, efficiency and reliability of job execution are critical. Some processes (e.g., jobs, workloads, etc.), called “anomaly jobs,” experience anomalies, such as execution times that are significantly higher than a threshold execution time. For example, an anomaly job may have an execution time that is several (e.g., three, four, or another number) deviations above the mean execution time. Cloud services offer root cause analysis (RCA) for explaining anomaly jobs, for example, by explaining the presence of anomalies detected in the anomaly jobs. For example, metrics and diagnostics services have end-to-end pipelines that collect various job features (e.g., metrics) and perform RCA of the features to predict or otherwise determine a contribution (e.g., a percentage, a proportion, a rating, or other contribution) of each feature of a set of features to the anomaly of the detected anomaly job.

### SUMMARY

In some aspects, the techniques described herein relate to a method of identifying a root cause of an anomaly in one or more distributed computing workflows, the method including: accessing computing metrics of features of the one or more distributed computing workflows, at least one of the computing metrics indicating the anomaly in the one or more distributed computing workflows; representing each feature of the features as a node in a causal graph and causal relationships between features as direct links between causing nodes and resulting nodes, wherein a root node of the causal graph corresponds to the anomaly; for each feature in each causal subgraph of multiple causal subgraphs of the causal graph, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and determining a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores; for an adjacent subgraph of the multiple causal subgraphs that includes unique features that are not in the root causal subgraph and a shared feature that is also in the root causal subgraph, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores; and identifying a root cause feature of the features of the causal graph contributing to the anomaly, the identified root cause feature having a determined non-adjacent root cause score that satisfies a root cause condition.

In some aspects, the techniques described herein relate to one or more tangible processor-readable storage media embodied with instructions for executing on one or more processors and circuits of a computing device a process for identifying a root cause of an anomaly in a distributed computing workflows, the process including: accessing computing metrics of features of the one or more distributed computing workflows, at least one of the computing metrics indicating the anomaly in the one or more distributed computing workflows; representing each feature of the features as a node in a causal graph and causal relationships between features as direct links between causing nodes and resulting nodes, wherein a root node of the causal graph corresponds to the anomaly; for each feature in each causal subgraph of multiple causal subgraphs of the causal graph, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and determining a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores; for an adjacent subgraph of the multiple causal subgraphs that includes unique features that are not in the root causal subgraph and a shared feature that is also in the root causal subgraph, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores; and identifying a root cause feature of the features of the causal graph contributing to the anomaly, the identified root cause feature having a determined non-adjacent root cause score that satisfies a root cause condition

In some aspects, the techniques described herein relate to a computing system for identifying a root cause of an anomaly in a distributed computing workflows, the computing system including: one or more hardware processors; an anomaly detector executable by the one or more hardware processors and configured to access computing metrics of features of the one or more distributed computing workflows, at least one of the computing metrics indicating the anomaly in the one or more distributed computing workflows; a causal graph generator executable by the one or more hardware processors and configured to retrieve a causal graph representing each feature as a node in the causal graph and causal relationships between features as direct links between causing nodes and resulting nodes, wherein a root node of the causal graph corresponds to the anomaly; a contributions calculator executable by the one or more hardware processors and configured to compute for each feature in each causal subgraph of multiple causal subgraphs of the causal graph, an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and a causal analyzer executable by the one or more hardware processors and configured to determine a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores; for an adjacent subgraph of the multiple causal subgraphs that includes unique features that are not in the root causal subgraph and a shared feature that is also in the root causal subgraph, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores, the causal analyzer further configured to identify a root cause feature of the features of the causal graph contributing to the anomaly, the identified root cause feature having a determined non-adjacent root cause score that satisfies a root cause condition

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which the metrics and diagnostics system (MDS) detects an anomaly in workflows executed by a distributed computing system and determines a predicted root cause for the anomaly.

FIG. 2 illustrates an example computing environment in which a metrics and diagnostics system (MDS) detects an anomaly in workflows and determines a predicted root cause for the anomaly.

FIG. 3 illustrates an example decomposition of a causal graph into two subgraphs for performing a hybrid RCA approach of the described technology.

FIG. 4 illustrates an example causal graph representing causal relationships between features of distributed computing workflows that is divisible into subgraphs for calculating nonadjacent contribution scores of the features representing a contribution of each of the features to the anomaly feature.

FIG. 5 illustrates examples of operations for identifying a root cause of an anomaly in one or more distributed computing workflows.

FIG. 6 illustrates an example computing device for implementing the described technology.

### DETAILED DESCRIPTION

Metrics and diagnostics systems have end-to-end pipelines that collect various workload features (e.g., metrics) and perform RCA to predict or otherwise determine a contribution (e.g., a percentage, a proportion, a rating, or other contribution) of each feature of a set of features to the anomaly of a detected anomaly workload. For example, an anomaly is a workload feature (e.g., a total execution time) that significantly deviates from an expected value. For example, a total execution time that is three standard deviations or more greater than an average or expected total execution time may be considered an anomaly. One method for RCA is to represent causal relationships between features in a causal graph and to analyze the contribution of each feature of a set of features of the causal graph to the anomaly as a resulting feature. For example, a causing feature has a causal relationship with a resulting feature because the causing feature causes or otherwise contributes to a resulting feature. For example, the causal graph represents features as nodes and causal relationships using connections between nodes. The connections may be directed links that point away from a causing node/feature to a resulting node/feature that is caused or influenced by the causing node/feature.

However, the computational complexity of RCA processes may increase exponentially as the number of features of the distributed computing workflows increases. In a traditional RCA approach, RCA is performed on an entire causal graph to determine the contribution of each feature of the causal graph. For example, the computational complexity of RCA may be 2\hat{ }n, where n represents the number of features. Accordingly, RCA to determine the contribution of each feature to an anomaly is challenging in scenarios in which the causal graph includes a large number (e.g., ten or more) of features of the anomaly and in scenarios in which the causal model graph itself is complex. For example, as the number of features increases, the time and/or computing resource usage required to process them grows exponentially, leading to severe performance issues that can cause significant delays and/or significant usage of computing resources when analyzing many features. Also, exponential growth in computational complexity may result in a corresponding increase in the consumption of resources such as memory and processing power, leading to higher energy consumption by metrics and diagnostics computing systems.

The hybrid RCA approach of the technology described herein addresses these problems by performing separate root cause sub-analyses on each subgraph of a set of subgraphs of a causal graph and determining a non-adjacent root cause contribution score of the features of the causal graph by combining adjacent root cause contribution scores of the features of the subgraphs determined in the sub-analyses. For example, the adjacent root cause score is a score representing a contribution of a causing node to adjacent resulting nodes in a causal subgraph. The nonadjacent root cause score is a score representing a contribution of a causing node to the anomaly (e.g., the root node) in the causal graph. Specifically, the hybrid RCA approach of the described technology decomposes a causal graph representing causal relationships between features into subgraphs, computes adjacent contribution scores of each feature within each subgraph, and modifies the adjacent contribution scores of the features through the subgraphs to determine a non-adjacent contribution score of each feature to the anomaly within the causal graph. Compared to an entire-graph RCA approach, the hybrid RCA approach of the described technology increases efficiency and reduces the complexity of computation for determining contributions of features to an anomaly of a detected anomaly workload. For example, performing separate root cause sub-analyses on each of the set of subgraphs and combining the sub-analyses to determine a final contribution of each feature is less computationally complex and less computationally costly than performing the entire-graph RCA approach and results in less bandwidth usage and cost.

In some implementations, a causal graph/subgraph may be represented by a directed acyclic graph (DAG), which is a graph structure that consists of vertices (nodes) and directed edges/links (e.g., arcs) where each edge has a direction. DAGs have no cycles, meaning it is impossible to start at a node and return to it by following the directed edges. However, it should be understood that other formats of graphs may be used. For example, the edge direction may point toward a causing node and away from a resulting node. In another example, the edge direction points away from a causing node and toward a resulting node. DAGs are acyclic and have no cycles. In other words, one cannot traverse the graph and return to the starting node by following the directed edges.

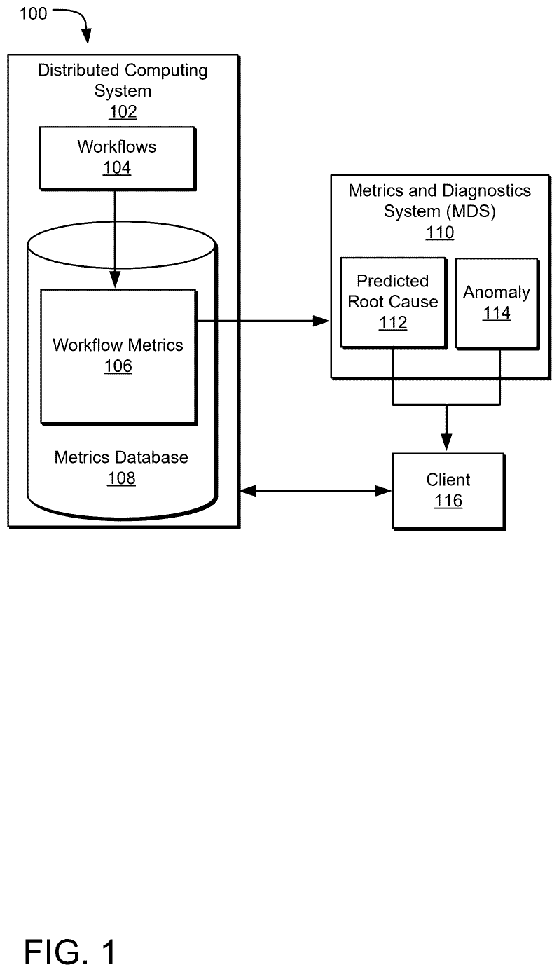

FIG. 1 illustrates an example computing environment 100 in which the metrics and diagnostics system (MDS) 110 detects an anomaly 114 in workflows 104 executed by a distributed computing system 102 and determines a predicted root cause 112 for the anomaly 114.

The distributed computing system 102 is a network of computing nodes that collaboratively execute workflows 104 and store workflow metrics 106 describing the workflows 104. Such computing nodes can be physical servers, virtual machines, or containers, and they may be connected through a network, such as a local area network (LAN), the Internet, or another network. The distributed computing system 102 includes a plurality of clients (e.g., client 116) that submit workflow requests to the distributed computing system. The distributed computing system 102 may communicate with clients (e.g., client 116) via a network, enabling clients to submit workflow requests and receive results. The workflows 104 may involve a series of computational tasks, such as data processing, machine learning model training, or large-scale simulations.

The distributed computing system 102, before, during, and/or after execution of the workflows 104, determines workflow metrics 106 for the workflows 104. The distributed computing system 102 stores the workflow metrics 106 in the metrics database 108 (e.g., a time-series database). The metrics database 108 allows for efficient querying, analysis, and visualization of the workflow metrics 106. For example, the metrics database 108 is searchable by one or more computing devices of the distributed computing system 102 or by one or more computing devices of the client 116. Each computing node in the distributed computing system 102 may be equipped with monitoring agents that track various workflow metrics 106 in real-time. The workflow metrics 106 corresponding to the workflows 104 can include metrics such as start time, end time, total execution time, resource utilization (e.g., average central processing unit (CPU) usage, total CPU usage, memory usage, disk usage, etc.), data throughput (e.g., amount of data processed, transferred, or stored) and task completion status (e.g., including success, failure, retry attempts, etc.). Workflow metrics 106 may include information about task initiation, progress, completion, and any errors encountered. The distributed computing system 102, in some examples, provides for display via the client 116, the workflow metrics 106 responsive to receiving a request from the client 116.

In some implementations, as depicted in FIG. 1, the MDS 110 is a separate computing system from the distributed computing system 102 and communicates with the distributed computing system 102. In some implementations, the MDS 110 is a subsystem of the distributed computing system 102. The MDS 110 receives or otherwise accesses the workflow metrics 106 from the metrics dataset 108 and, performs analysis of the workflow metrics 106 and reports the analysis to the client 116. Performing the analysis may include detecting an anomaly 114 in the workflows 104 based on the workflow metrics 106 and then performing a hybrid RCA process on the workflow metrics 106 to determine a predicted root cause 112 of the anomaly 114. For example, workflows 104 includes a set of features, and the hybrid RCA process determines, for each of the set of features and based on causal relationships between the features and based on the workflow metrics 106, a contribution, a attribution, a score, a ranking, or other value or indicator that explains an influence of the feature on the anomaly 114. The hybrid RCA process may involve accessing a causal graph (e.g., from the metrics database 108) that represents features of the workflows 104 using nodes and causal relationships between the features using edges (e.g., connections, links, arcs) between the nodes. The hybrid RCA process may involve dividing the causal graph into a set of subgraphs and performing RCA on each of the subgraphs to determine adjacent attributes (e.g., a contribution score, attribution score, ranking, value, or other indicator) for each node (e.g., feature) in the subgraph for any resulting nodes linked to the node. For example, a respective adjacent attribute is calculated for the node (e.g., as a causing node) for each resulting node that is linked to the node in the causal subgraph. The hybrid RCA process may involve modifying the adjacent attributes of the nodes through the subgraphs to determine a non-adjacent attribute of each node indicating a contribution to the anomaly within the causal graph.

Clients (e.g., the client 116) can interact with the distributed computing system 102 (e.g., through APIs) to submit the workflows 104 and retrieve results of the workflows 104. The client 116 may be a computing device or software application. The client 116 may interact (e.g., with a server or a set of servers) with the distributed computing system 102 to request and receive services, data, or computational resources from the distributed computing system 102. The client 116 may operate as an endpoint in a network, requesting processing tasks (e.g., the workflows 104) from the distributed computing system 102 and receiving output data of the processing tasks as directed by a user or as directed by automated processes. In some implementations, the clients may interact with the MDS 110 to retrieve workflow metrics 106 and/or diagnostics (e.g., an anomaly 114 detected in the workflows 104 and a corresponding predicted root cause 112) generated by the MDS 110.

In an example, the distributed computing system 102 receives a request from the client 116 (e.g., a retail company) to process the workflows 104 (e.g., determining predicted sales trends from a large customer dataset including customer identifiers, purchase dates, product identifiers, quantities, and prices). The distributed computing system 102 executes the workflows 104, determines the workflow metrics 106 before, during, and/or after execution of the workflows 104, and stores the workflow metrics 106 in the metrics database 108. For example, the workflow metrics 106 include a total execution time for each of a set of steps in the workflows 104 or for each of a set of processes in the workflows 104. For example, the workflow metrics 106 include a training time for a first model, an inference time for the first model, a training time for a second model, an inference time for a second model, an execution time for a subsequent process, etc. The MDS 110 receives or otherwise accesses the workflow metrics 106 and determines, for the workflows 104 and, based on the workflow metrics 106, an anomaly 114 of the workflows 104. For example, the anomaly 114 is the execution time for the workflows 104, which is three standard deviations above the mean execution time when execution times of all workflows processed by the distributed computing system 102 are averaged. The MDS 110 performs, using a causal graph and the workflow metrics 106, a hybrid RCA process to determine a predicted root cause 112 (e.g., an execution time for a subprocess of the workflows 104) for the anomaly 114. For example, the causal graph represents the workflows 104 using nodes representing features and connections between the nodes representing causal relationships between the features. Performing the hybrid RCA process involves dividing the causal graph into a plurality of subgraphs, determining an adjacent contribution of each node of each subgraph to any resulting nodes connected to the node, and determining a nonadjacent contribution of each node of the causal graph to the root node corresponding to the anomaly based on the adjacent contributions determined from the subgraphs. The MDS 110 transmits an identification of the anomaly 114 (the execution time of the workflows 104) and the predicted root cause 112 (e.g., the feature having the highest nonadjacent contribution) to the client 116.

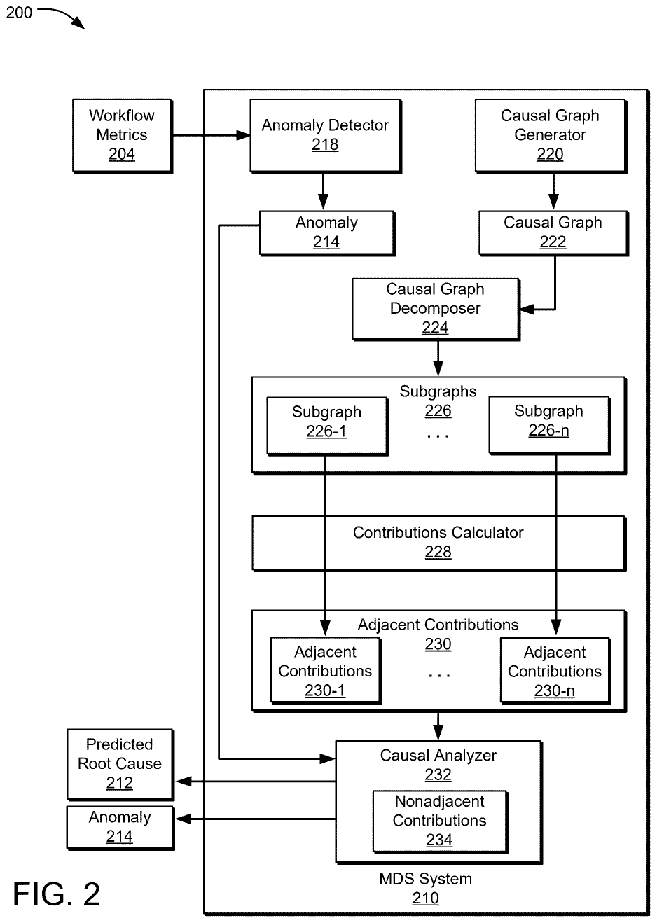

FIG. 2 illustrates an example computing environment 200 in which a metrics and diagnostics system (MDS) 210 detects an anomaly 214 in workflows and determines a predicted root cause 212 for the anomaly 214.

The MDS 210 may receive the workflow metrics 204 or otherwise access the workflow metrics 204 from a distributed computing system that processes the workflows for which the workflow metrics 204 are determined. In some implementations, the MDS 210 processes the workflows and determines the workflow metrics 204. The MDS 210 analyzes the workflow metrics 204 and generates results of the analysis (e.g., including the anomaly 214 and the predicted root cause 212). In some implementations, the MDS 210 reports the results of the analysis to a client (e.g., a client of the MDS 210 and/or of the distributed computing system that processed the workflows for which the workflow metrics 204 were determined).

In some implementations, the MDS 210 includes an anomaly detector 218, a causal graph generator 220, a causal graph decomposer 224, a contributions calculator 228, and a causal analyzer 232.

The anomaly detector 218 receives the workflow metrics 204 or otherwise accesses the workflow metrics 204 from a distributed computing system that processes the workflows for which the workflow metrics 204 are determined. The anomaly detector 218 may receive or otherwise access the workflow metrics 204 responsive to receiving a request to perform an analysis of the workflow metrics 204. The anomaly detector 218 detects anomalies (e.g., the anomaly 214) in the workflows for which the workflow metrics 204 were determined based on the workflow metrics 204. For example, the anomaly may be a workflow metric that is anomalous, for example, it is a predefined amount (e.g., a predefined number of standard deviations) from a mean amount. In some implementations, the anomaly detector 218 uses an algorithm detection process (e.g., a pipeline, an algorithm) to determine the anomaly 214 based on the workflow metrics 204. The anomaly detector 218 may leverage advanced statistical methods and machine learning algorithms to detect anomalies in real-time before, during, and/or after the processing of the workflows to identify outliers (e.g., values that deviate from the mean according to one or more predefined criteria), irregularities, unusual patterns in time series data, predefined trigger thresholds for one or more metrics, rule-based predefined anomalies having predefined trigger conditions, or other anomalies. The anomaly detector 218 may access one or more stored rules or instructions for finding anomalies in the workflow metrics 204 and may detect the anomaly 214 of the workflows by analyzing the workflow metrics 204 in accordance with the stored rules or instructions.

For example, the anomaly detector 218 classifies the workflows corresponding to the workflow metrics 204 as having the anomaly 214 based on the workflow metrics 204. For example, a workflow metric indicates that the execution time of the workflows is greater than a predefined threshold. For example, the predefined threshold is an expected execution time of the workflows, an expected maximum execution time of the workflows, an execution time greater than (e.g., 50% greater than) the expected execution time of the workflows, or another predefined threshold. The predefined threshold may be a number (e.g., 2, 2.3, 2.8, 3, or other number) of standard deviations greater than the average execution time of workflows executed by the distributed computing system and/or the MDS 210. In this example, the anomaly detector 218 classifies the workflows as an anomaly responsive to determining that the execution time workflow metric is greater than the predefined threshold. In some implementations, the anomaly detector 218 classifies the workflows corresponding to the workflow metrics 204 as having an anomaly 214 based on determining that another metric other than execution time (e.g., CPU usage, memory usage, or another metric) of the workflows is greater than a predefined threshold.

The causal graph generator 220 generates or otherwise retrieves (e.g., from a metrics database of a distributed computing system that processed the workflows or from a metrics database of the MDS 210) a causal graph 222 that represents causal relationships between features determined from the workflow metrics using nodes that represent the features and direct links between nodes representing the causal relationships. Generating the causal graph 222 may include recording the features in the causal graph as nodes and recording the causal relationships between the features as direct links between the nodes. In some implementations, an operator of the MDS 210 or of the distributed computing system (e.g., an analyst) generates the causal graph by recording the features as nodes and the causal relationships as direct links between nodes in the causal graph 222 and storing the causal graph 222. In these implementations, the causal graph generator 220 retrieves the stored causal graph 222. For example, features may be workflow metrics or features calculated from or otherwise determined based on one or more workflow metrics. For example, a workflow metric is a determined memory usage. In another example, a workflow metric is a duration calculated from a determined start time workflow metric and a determined end time workflow metric.

The causal graph 222 represents features of the workflows 104 using nodes and causal relationships between the features using connections (e.g., edges, links) between the nodes. The connections may be directional (e.g., directed edges) and may point toward a causing node and away from a resulting node that is caused by or otherwise influenced by the causing node. In other implementations, the direction of the directed edges points away from a causing node and toward a resulting node. In some implementations, the connections are not directional and the causal relationship is represented by other information in the causal graph (e.g., other data associated with nodes and/or links).

In some implementations, the causal graph generator 220 analyzes the workflows (e.g., the underlying code), identifies features of the workflows and causal relationships among features, and generates the causal graph 222 having features represented as nodes and the causal relationships represented as connections between the nodes. In some implementations, an operator (e.g., an analyst) of the distributed computing system or of the MDS 210 generates the causal graph 222 that represents causal relationships among features of the workflows.

The causal graph decomposer 224 decomposes (e.g., divides) the causal graph 222 into n subgraphs 226 (e.g., subgraph 226-1, . . . , subgraph 226-n) of the causal graph 222, each of the subgraphs 226 having a different proper subset of nodes of the causal graph 222. One or more edge nodes of each of the subgraphs 226 overlap with one or more edge nodes of other subgraphs. The causal graph decomposer 224 applies a graph decomposition process to divide the causal graph 222 into two of the subgraphs 226. This graph decomposition process may be repeated multiple times to generate a set of subgraphs 226 of the causal graph 222. The graph decomposition process involves identifying a prominent node in the causal graph 222 and removing a subtree rooted at a child node of the identified prominent node if the child node has descendant nodes. The prominent node may be identified based on a relationship of the prominent node with causing and resulting nodes linked to the prominent node. In an example, node having a contribution that can be isolated from a contribution of its sibling nodes (e.g., which all result from a same causing node) may be identified as the prominent node. In this example, a node that has a contribution that cannot be isolated from contributions of its sibling nodes is not identified as the prominent node. The causal graph decomposer adds, where the causal graph 222 was split, a leaf node (e.g., a terminal node) with the copy of the child node that was removed, resulting in a second subgraph. In other words, the causal graph decomposer, in a graph decomposition operation, splits the causal graph 222 into two subgraphs by removing a node and its subtree from a prominent node identified in the causal graph 222 and adding, to the causal graph 222 (having the removed subtree) a copy of the removed node as a leaf node to the prominent node.

The graph decomposition process may be repeated multiple times on the causal graph 222 to yield a set of subgraphs 226 of the causal graph 222. In implementations, if the identified child node is a leaf node (e.g., an external node, a terminal node, or other node having no descendant nodes) of the prominent node, the graph decomposition process selects another child node of the prominent node in the causal graph 222 that is not a leaf node and removes the subtree of the other selected child node. If all child nodes of the prominent node are leaf nodes, the causal graph decomposer 224 identifies another prominent node and performs the graph decomposition process with the other identified prominent node, and so forth.

For example, node X₀ is a selected prominent node in the causal graph 222 (represented as G), and nodes X₁, . . . , X_{c}, Y₀ are child nodes of the prominent node X₀, where the prominent node has c+1 child nodes. Also, nodes X₁, . . . , X_{c}, Y₀, Y₁ represent descendant nodes of the prominent node X₀. Further, the child node Y₀ has e descendant nodes Y₁, . . . , Yₑ. The relationship of dependency (e.g., causation) between the prominent node X₀ and its child nodes is of the form X₀=ƒ(Y₀)+g(X₁, . . . , X_{c})+N₀, where N₀ represents noise associated with the selected prominent node X₀, and function ƒ( ) and function g( ) describe the dependency (e.g., causation) relationship as a function of the child node Y₀ and of the descendant nodes of the prominent node X₀ other than the child node Y₀, respectively. In this example, the prominent node X₀ is identified as the prominent node because the contribution of the child node Y₀ can be separated from contributions of nodes X₁, . . . , X_{c}. However in cases where multiple sibling nodes of child node Y₀ exist, for example if Y₀ and Y₁ are sibling nodes that are both causal nodes linked to X₀, then both Y₀ and Y₁ may be identified as prominent nodes.

In this example, a subgraph G₁ is obtained by removing the subtree rooted at the child node Y₀ from causal graph G and replacing it with a duplicate of the child node Y₀ as a leaf node. However, if the child node Y₀ is already a leaf node, the subgraph G₁ remains the same as the subgraph G and, and the causal graph decomposer 224 selects another prominent node in graph G for performing graph decomposition processes. In implementations, the causal graph decomposer 224 continues to perform graph decomposition until all prominent nodes are identified and the graph is split at all identified prominent nodes and the subtree rooted at the split node is replaced with the node as a leaf node.

The contributions calculator 228 determines, for each subgraph of the n subgraphs 226 (e.g., the subgraph 226-1, . . . , the subgraph 226-n), adjacent contributions (e.g., adjacent contributions 230-1, . . . , adjacent contributions 230-n) of the nodes in the subgraph to the anomaly 214. For example, the contributions calculator 228 performs RCA on each of the subgraphs 226 to determine a corresponding adjacent contribution (e.g., an adjacent contribution score). Performing the RCA on the subgraph can include using a machine learning model that is trained to determine, for each of the nodes of a subgraph, an contribution of the node in the subgraph to each adjacent node to the node which is linked to the node in a causal relationship in which the node is the causing node. For example, for each node in a subgraph, the contributions calculator 228 determines a respective adjacent contribution score of the node for each resulting node that is connected to (e.g., via a directed link) the node. For example, the node is a causing node if the directed link is pointing toward the node and away from an adjacent resulting node. The machine learning model may include one or more decision trees, support vector machines (SVMs), k-nearest neighbor (KNN) models, Bayesian networks, ensemble methods, deep learning models such as neural networks (e.g., graph neural networks), isolation forests, hierarchical memory networks, autoencoders, or other models. The adjacent contributions 230 may include, for each of the nodes of each subgraph, an adjacent contribution score for each resulting node that is linked to the node (e.g., via a directed link that points toward the node or otherwise indicates that the node is the causing node). Based on the adjacent contributions 230 calculated for the subgraphs 226, the causal analyzer 232 determines nonadjacent contributions 234 of the nodes in the causal graph. The nonadjacent contributions 234 are the contributions of each node of the causal graph to the root node that corresponds to the anomaly 214.

The adjacent contribution of a node u in a subgraph may denote a contribution of the node u to an adjacent node v in the subgraph obtained from a hybrid RCA algorithm, which may be represented as S_{H}(u→v), where H represents the subgraph. The node u is a causing node to the adjacent node v in the subgraph and the adjacent node v in the subgraph is the resulting node caused by (or otherwise influenced by) the causing node u.

In scenarios in which a subgraph is a leaf node (e.g., having no child nodes itself) of a prominent node X₀ of the causal graph 222, for the nodes (e.g., features) (X₁, . . . , X_{d}) and Y₀ (e.g., the leaf node), which are child nodes of the prominent node X₀, the causal analyzer 232 assigns to the nodes of the graph the corresponding adjacent contributions obtained from a subgraph (G₁), as follows:

$${S}_{G} ( u \to {X}_{0} ) = {S}_{{G}_{1}} ( u \to {X}_{0} ) , ∀ u ∈ {X}_{1} , … , {X}_{c} , {Y}_{0} . \qquad ( 1 )$$

Here, S_{G}(u→X₀) denotes the non-adjacent contribution of the node within the causal graph 222 to the prominent node X₀ and S_{G}_{₁}(u→X₀), ∀u∈X₁, . . . , X_{c}, Y₀ denotes the adjacent contribution of the node u within the subgraph to the prominent node X₀.

In scenarios in which the subgraph is not a leaf node (e.g., the subgraph is more than a leaf node only and has e descendant nodes) of a prominent node X₀ of the causal graph 222, the causal analyzer 232 uses a scaled version of attribute scores obtained for the e descendant nodes Y₁, . . . , Yₑ as follows:

$${S}_{G} ( u \to {X}_{0} ) = {S}_{{G}_{2}} ( u \to {Y}_{0} ) \frac{{S}_{G} ( {Y}_{0} \to {X}_{0} )}{{E}^{*} ( {Y}_{0} ) - E ( {Y}_{0} )} , ∀ u ∈ {Y}_{1} , … , {Y}_{e} , \qquad ( 2 )$$

where S_{G}(u→X₀) denotes the non-adjacent contribution of the node within the causal graph 222 to the prominent node X₀,

$${S}_{{G}_{2}} ( u \to {Y}_{0} ) \frac{{S}_{G} ( {Y}_{0} \to {X}_{0} )}{{E}^{*} ( {Y}_{0} ) - E ( {Y}_{0} )} ,$$

∀u∈Y₁, . . . , Yₑ, denotes the adjacent contribution of the node u within the subgraph to the adjacent child node Y₀ in previous subgraph, and where the scaling value of

$$\frac{{S}_{G} ( {Y}_{0} \to {X}_{0} )}{{E}^{*} ( {Y}_{0} ) - E ( {Y}_{0} )}$$

reduces the computed contribution of nodes in the subgraph based on the non-adjacent contribution of Y₀ to X₀. For example, the scaling value shrinks the computed contribution according the contribution of Y₀ to X₀ (the root node of the whole graph, i.e., the target) where E*(Y) denotes the anomaly value of Y₀ and E(Y₀) the normal value of this feature. As long as the contribution of Y₀ and the other variables to the prominent node X₀ can be separated, this chain rule computes the exact value of the contribution. In implementations in which multiple paths exist for propagation from the root node (e.g., the prominent node X₀), the contribution of the node to the root node of the graph equals to the sum of the contribution of each path.

Based on the chaining rule derived as in Equation (2), the causal graph 222 can be decomposed into a set of subgraphs 226 and the nonadjacent contributions 234 of the causal graph 222 can be computed based on combining adjacent contributions 230 for the nodes of each of the subgraphs. For example, a causal graph 222 that is split into three subgraphs G₁, G₂, and G₃, where G₁ includes the prominent (e.g., root) node X₀ and c+1 primary descendant nodes X₁, . . . , X_{c}, Y₀ G₂ includes a specific primary descendant node Y₀ of the primary child nodes and n+1 descendant secondary nodes Y₁, . . . , Yₙ, Z₀ that are descendant nodes of the specific primary descendant node Y₀, and G₃ includes a specific secondary descendant node Z₀ of the n+1 secondary descendant nodes and e tertiary descendant nodes Z₁, . . . , Zₑ that are descendant nodes of the specific secondary descendant node Z₀. In this example, adjacent contributions are calculated for nodes in the subgraphs G₁, G₂, and G₃. In this example, nonadjacent contributions of tertiary descendant nodes of subgraph G₃ are calculated according to the following equation:

$${S}_{G} ( u \to {X}_{0} ) = {S}_{{G}_{3}} ( u \to {Y}_{0} ) \frac{{S}_{G} ( {Y}_{0} \to {X}_{0} )}{{E}^{*} ( {Y}_{0} ) - E ( {Y}_{0} )} * \frac{{S}_{G} ( {Z}_{0} \to {Y}_{0} )}{{E}^{*} ( {Z}_{0} ) - E ( {Z}_{0} )} , \\ ∀ u ∈ {Z}_{1} , … , {Z}_{e} , \qquad ( 3 )$$

where Z₀ denotes the specific secondary node in subgraph G₃ that is also a node in subgraph G₂, where Z₁, . . . , Zₑ denotes the descendant nodes of Z₀ within subgraph G₃, where S_{G}(u→X₀) denotes the non-adjacent contribution of the node within the causal graph 222 to the prominent node X₀, where S_{G}_{₃}(u→Z₀) denotes the adjacent contribution of the node u within the subgraph G₃ to the specific secondary descendant node Z₀ of subgraph G₃ that is also in the previous subgraph G₂ multiplied by a scaling value of

$$\frac{{S}_{G} ( {Y}_{0} \to {X}_{0} )}{{E}^{*} ( {Y}_{0} ) - E ( {Y}_{0} )} * \frac{{S}_{G} ( {Z}_{0} \to {Y}_{0} )}{{E}^{*} ( {Z}_{0} ) - E ( {Z}_{0} )} .$$

The scaling factor of Equation (3) reduces the computed contribution of nodes Z₁, . . . , Zₑ in the subgraph G₃ based on the non-adjacent contribution of Y₀ to X₀ as well as the non-adjacent contribution of Z₀ to X₀, where E*(Z₀) denotes the anomaly value of Z₀ and E(Z₀) the normal value of this feature.

The causal analyzer 232 determines, for the anomaly 214 detected in the workflows, a predicted root cause 212 based on the adjacent contributions (e.g., adjacent contributions 230-1, . . . , adjacent contributions 230-n) of the nodes in each of the n subgraphs 226 (e.g., subgraph 226-1, . . . , subgraph 226-n). The predicted root cause 212 may include a non-adjacent contribution (e.g., a score, a proportion, a percentage, a ranking, and/or a category, etc.) for each node of the causal graph 222 to the anomaly 214, whether or not the node is linked directly or indirectly to the root node that corresponds to the anomaly 214. The predicted root cause 212 may include an identity feature(s) that correspond to a node or subset of nodes of the causal graph 222 that has/have the most impact/influence on the anomaly 214 (e.g., the root node of the causal graph).

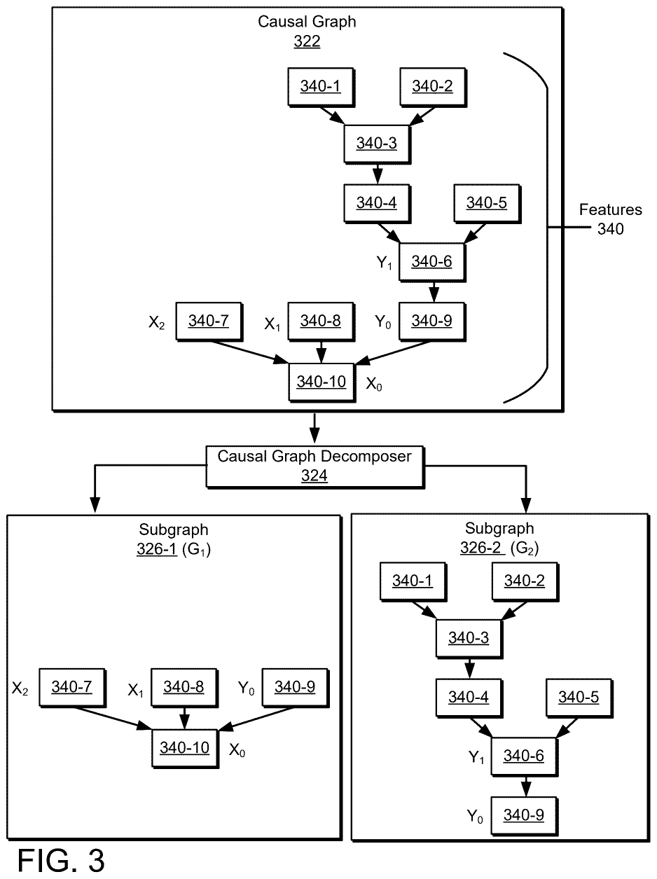

FIG. 3 illustrates an example decomposition of a causal graph 322 into two subgraphs for performing a hybrid RCA approach of the described technology. The causal graph 322 includes a set of features 340 represented as nodes (e.g., ten features including feature 340-1, feature 340-2, feature 340-3, feature 340-4, feature 340-5, feature 340-6, feature 340-7, feature 340-8, feature 340-9, and feature 340-10), and causal relationships represented as connections between the nodes. For example, the features may be a processing time for each of a set of ten processes performed in workflows represented by the causal graph 322. For example, in the causal graph 322 depicted in FIG. 3, the arrows (e.g., denoting edges) point toward resulting features and away from causing features. For example, a feature is a causing feature if it causes or otherwise affects or contributes to a resulting feature to which it is connected in the causal graph. For example, a total duration feature is a resulting feature of a queuing time causal feature and an application run time causal feature because both the queuing time and the application run time metrics cause or otherwise affect the total duration metric. In this example, the application run time causal feature is a resulting feature of each of a starting time causal feature, an idle time causal feature, a compilation time causal feature, and an execution time causal feature because the metrics corresponding to each of these causal features causes or otherwise affects the application run time metric.

The causal graph decomposer may decompose the causal graph 322 into subgraphs (e.g., subgraph 326-1 and subgraph 326-2) by splitting the causal graph 322 at a prominent node (e.g., feature 340-3).

For example, feature 340-10 (X₀) is a selected prominent node in the causal graph 222 (represented as G), and features 340-7, 340-8, and 340-9 (X₁, . . , X_{c}, Y₀) are child nodes of the prominent node X₀, where the prominent node has c+1 (e.g., 3) child nodes. Also, features 340-1, 340-2, 340-3, 340-4, 340-5, 340-6, 340-7, 340-8, and 340-9 (X₁, . . . , X_{c}, Y₀, Y₁ . . . ) represent descendant nodes of the prominent node, feature 340-10 (X₀). Further, the child node feature 340-9 (Y₀) has 5 (e.g., e) descendant nodes, features 340-1, 340-2, 340-3, 340-4, 340-5 (Y₁, . . . , Yₑ). The relationship of dependency (e.g., causation) between the prominent node, feature 340-10 (X₀) and its child nodes is of the form X₀=ƒ(Y₀)+g(X₁, . . . , X_{c})+N₀, where N₀ represents noise associated with the selected prominent node, feature 340-10 (X₀), and function ƒ( ) and function g( ) describe the dependency (e.g., causation) relationship as a function of the child node, feature 340-9 (Y₀) and of the descendant nodes of the prominent node, feature 340-10 (X₀) other than the child node, feature 340-9 (Y₀), respectively. In this example, a subgraph 326-1 (G₁) is obtained by removing the subtree rooted at the child node, feature 340-9 (Y₀) from causal graph 322 (G) and replacing it with a duplicate of the child node, feature 340-9 (Y₀) as a leaf node. However, if scenarios in which the child node, feature 340-9 (Y₀) is already a leaf node (which is not the case in the example causal graph of FIG. 3), the subgraph remains the same as the causal graph 322 (G) and, and the causal graph decomposer 224 selects another prominent node X, in the causal graph 322 (G) for performing graph decomposition processes, and so forth, until all of the prominent nodes are identified and the causal graph 322 is split at each of the identified prominent nodes to form multiple subgraphs.

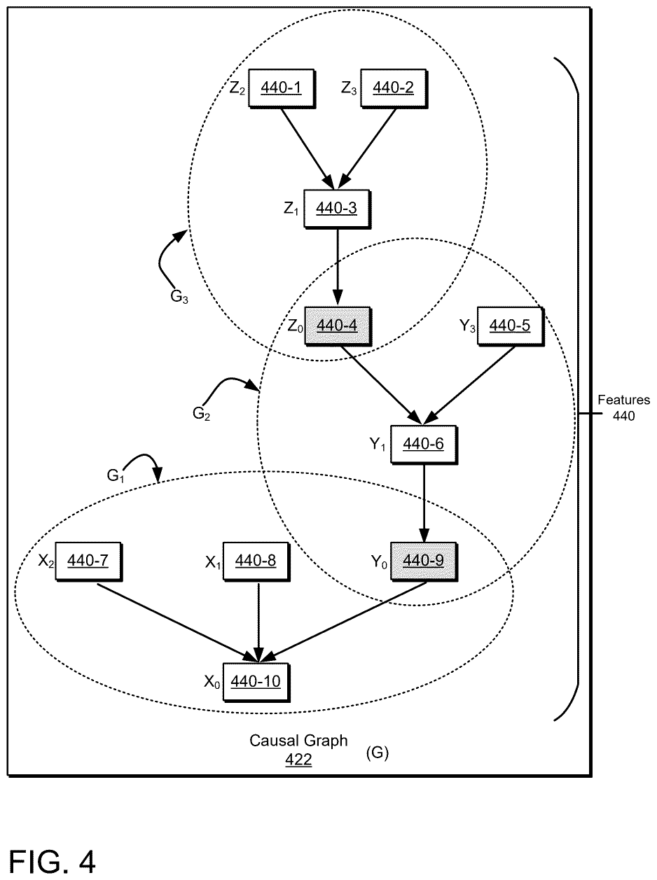

For example, to generate subgraph 326-1, the causal graph decomposer 324 splits the causal graph 322 at the directed edge between features 340-6 and feature 340-9 and adds a copy of feature 340-9 to the resulting subgraph 326-1, where subgraph 326-2 includes the descendant node (e.g. feature 340-9) of the prominent node (e.g., feature 340-10) and its descendant nodes. Subgraph 326-2 may be further divided sequentially into one or more further subgraph(s) by the causal graph decomposer 324. For example, the causal graph decomposer 324 may split the subgraph 326-2 at the directed edge between feature 340-3 and feature 340-4. FIG. 4, for example, illustrates such a divisibility of the causal graph 322 into three subgraphs.

FIG. 4 illustrates an example causal graph representing causal relationships between features of distributed computing workflows that is divisible into subgraphs for calculating nonadjacent contribution scores of the features representing a contribution of each of the features to the anomaly feature.

The causal graph 422 includes a set of features 440 represented as nodes (e.g., ten features including feature 440-1, feature 440-2, feature 440-3, feature 440-4, feature 440-5, feature 440-6, feature 440-7, feature 440-8, feature 440-9, and feature 440-10), and causal relationships represented as connections between the nodes. For example, the features may be a processing time for each of a set of ten processes performed in workflows represented by the causal graph 422. For example, in the causal graph 422 depicted in FIG. 4, the arrows (e.g., denoting edges) point toward resulting features and away from causing features. For example, a feature is a causing feature if it causes or otherwise affects or contributes to a resulting feature to which it is connected in the causal graph.

As illustrated in FIG. 4, the causal graph 422 is divisible into three subgraphs G₁, G₂, and G₃, denoted using dashed ovals that encompass the features and edges of the causal graph 422 included within each subgraph. For example, subgraph G₁ includes feature 440-10, feature 440-7 and its causal link to feature 440-10, feature 440-8 and its causal link to feature 440-10, and feature 440-9 and its causal link to feature 440-10. Subgraph G₂ includes feature 440-9, feature 440-6 and its causal link to feature 440-9, feature 440-4 and its causal link to feature 440-6, and feature 440-5 and its causal link to feature 440-6. Subgraph G₃ includes feature 440-9, feature 440-6 and its causal link to feature 440-9, feature 440-4 and its causal link to feature 440-6, and feature 440-5 and its causal link to feature 440-6. As indicated via shading, feature 440-9 is included in both subgraph G₁ and subgraph G₂ and feature 440-4 is included in both subgraph G₂ and subgraph G₃.

In an example, an MDS system determines, for each of the ten features 440, an adjacent contribution of the feature (as a causing feature) to each of one or more resulting features that are linked to the feature. For example, the MDS system determines for subgraph G₁, an adjacent contribution of feature 440-7 to feature 440-10, an adjacent contribution of feature 440-8 to feature 440-10, and an adjacent contribution of feature 440-9 to feature 440-10. The MDS system determines for subgraph G₂, an adjacent contribution of feature 440-6 to feature 440-9, an adjacent contribution of feature 440-4 to feature 440-6, and an adjacent contribution of feature 440-5 to feature 440-6. The MDS system determines for subgraph G₂, an adjacent contribution of feature 440-3 to feature 440-4, an adjacent contribution of feature 440-1 to feature 440-3, and an adjacent contribution of feature 440-2 to feature 440-3.

Within the subgraph G₁, the MDS system determines, using Equation (1), each of a nonadjacent contribution of feature 440-7 to feature 440-10, a nonadjacent contribution of feature 440-8 to feature 440-10, and a nonadjacent contribution of feature 440-9 to feature 440-10.

Within the subgraph G₂, the MDS system obtained the nonadjacent contribution of feature 440-9 to feature 440-10 using Equation (1). The MDS system determines, using Equation (2), a nonadjacent contribution of feature 440-6 to feature 440-10 by scaling the adjacent contribution of feature 440-6 to feature 440-9 by the nonadjacent contribution of feature 440-9 to feature 440-10. Similarly, the MDS system determines, using Equation (2), a nonadjacent contribution of feature 440-4 to feature 440-10 by scaling the adjacent contribution of feature 440-4 to feature 440-6 by the nonadjacent contribution of feature 440-9 to feature 440-10. Similarly, the MDS system determines, using Equation (2), a nonadjacent contribution of feature 440-4 to feature 440-5 by scaling the adjacent contribution of feature 440-5 to feature 440-6 by the nonadjacent contribution of feature 440-9 to feature 440-10.

Within the subgraph G₃, the MDS system obtained the nonadjacent contribution of feature 440-4 to feature 440-10 using Equation (2). The MDS system determines, using Equation (3), a nonadjacent contribution of feature 440-3 to feature 440-10 by scaling the adjacent contribution of feature 440-3 to feature 440-4 by the nonadjacent contribution of feature 440-4 to feature 440-10 and by the nonadjacent contribution of feature 440-9 to feature 440-10. Similarly, the MDS system determines, using Equation (3), a nonadjacent contribution of feature 440-1 to feature 440-10 by scaling the adjacent contribution of feature 440-1 to feature 440-3 by the nonadjacent contribution of feature 440-4 to feature 440-10 and by the nonadjacent contribution of feature 440-9 to feature 440-10. Similarly, the MDS system determines, using Equation (3), a nonadjacent contribution of feature 440-2 to feature 440-10 by scaling the adjacent contribution of feature 440-2 to feature 440-3 by the nonadjacent contribution of feature 440-4 to feature 440-10 and by the nonadjacent contribution of feature 440-9 to feature 440-10.

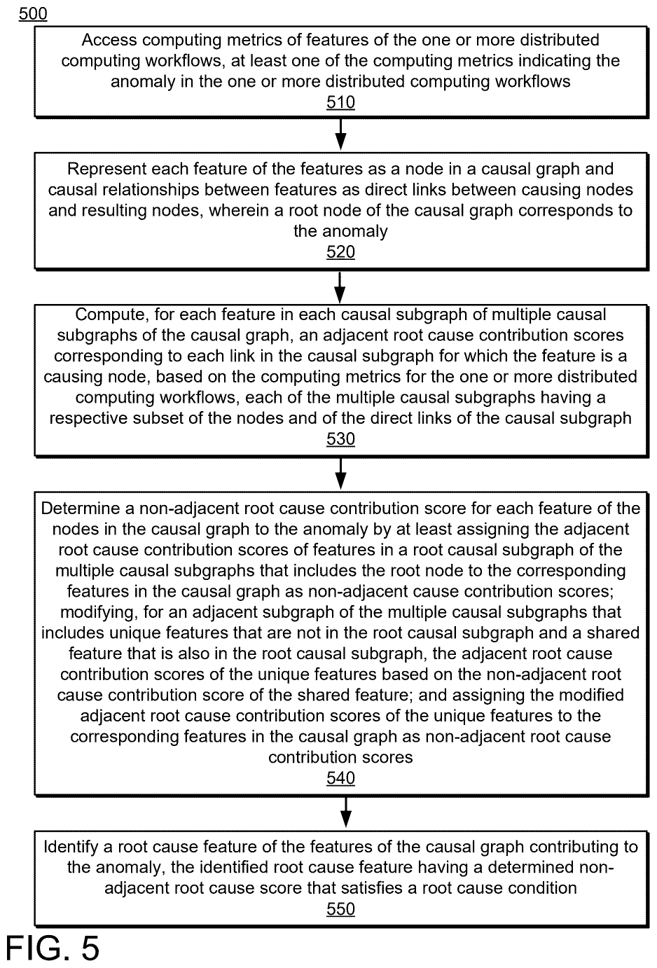

FIG. 5 illustrates examples of operations 500 for identifying a root cause of an anomaly in one or more distributed computing workflows.

An accessing operation 510 accesses computing metrics of features of the one or more distributed computing workflows, at least one of the computing metrics indicating the anomaly in the one or more distributed computing workflows. The computing metrics may include, for each feature of the features, a corresponding total processing duration. The computing metrics may include, for each feature of the features, a corresponding usage of memory.

A recording operation 520 records each feature of the features as a node in a causal graph and causal relationships between features as direct links between causing nodes and resulting nodes, wherein a root node of the causal graph corresponds to the anomaly (e.g., an anomaly feature of the features). For example, the recording operation 520 stores the causal graph that includes nodes corresponding to the features and direct links between the nodes modeling the causal relationships. The direct links in the causal graph may be directed links that point from the resulting nodes to the causing nodes.

A computing operation 530 computes, for each feature in each causal subgraph of multiple causal subgraphs of the causal graph, an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph. For example, the causal graph may be decomposed into the multiple causal subgraphs of the causal graph by at least splitting the causal graph into the root causal subgraph and the adjacent causal subgraph at a directed link between the shared feature and at least one of the unique features and by adding, to the root causal graph, the shared feature to the directed link from which the adjacent causal graph was split from the causal graph.

A determining operation 540 determines a non-adjacent root cause contribution score for each feature of the nodes in the causal graph to the anomaly by at least assigning the adjacent root cause contribution scores of features in a root causal subgraph of the multiple causal subgraphs that includes the root node to the corresponding features in the causal graph as non-adjacent cause contribution scores; modifying, for an adjacent subgraph of the multiple causal subgraphs that includes unique features that are not in the root causal subgraph and a shared feature that is also in the root causal subgraph, the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores. In some implementations, the adjacent root cause contribution scores of the unique features are modified based on the non-adjacent root cause contribution score of the shared feature and a scaling factor. In some implementations, determining the non-adjacent root cause contribution score for each feature of the nodes in the causal graph to the anomaly further comprises: for a subsequent adjacent subgraph of the multiple causal subgraphs that includes subsequent unique features that are not in the root causal subgraph and are not in the adjacent causal subgraph and a subsequent shared feature that is also in the adjacent causal subgraph, modifying the adjacent root cause contribution scores of the subsequent unique features based on the non-adjacent root cause contribution score of the subsequent shared feature.

An identifying operation 550 identifies a root cause feature of the features of the causal graph contributing to the anomaly, the identified root cause feature having a determined non-adjacent root cause score that satisfies a root cause condition. In some implementations, the identifying operation 550 further includes triggering an analysis of the determined root cause feature and communicating the analysis to a client computing device.

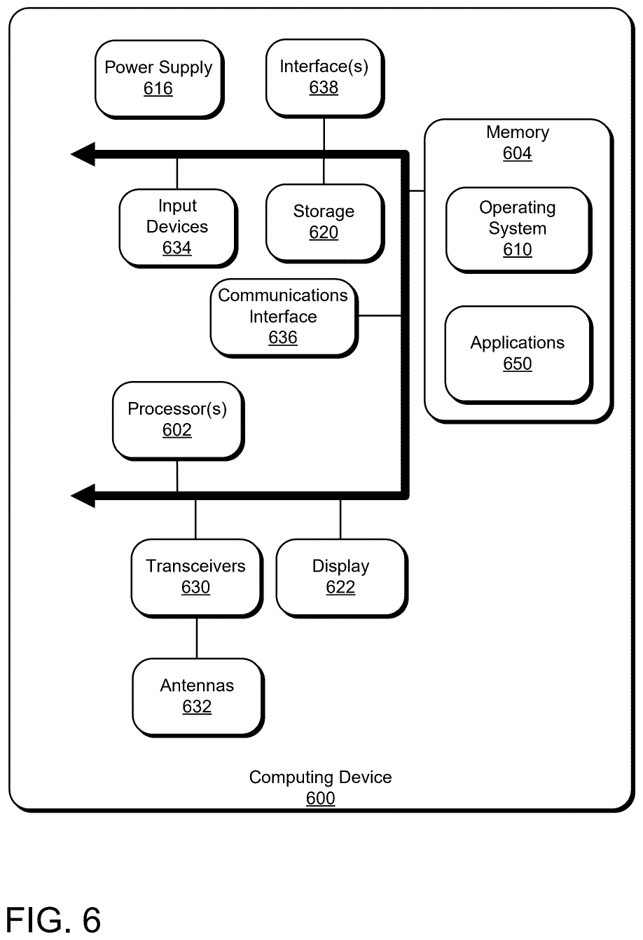

FIG. 6 illustrates an example computing device 600 for implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as an MDS, an anomaly detector, a causal graph generator, a causal graph decomposer, a contributions calculator, a causal analyzer, a client, applications 650, and other program code and modules are loaded into the operating system 610 on the memory 604 and/or the storage 620 and executed by the processor(s) 602. The storage 620 may store data (e.g., including workflow metrics, detected anomalies, causal graphs, subgraphs, adjacent contributions scores, nonadjacent contributions scores, or other data) and be local to the computing device 600 or may be remote and communicatively connected to the computing device 600. In particular, in one implementation, components of a system for reducing energy usage of a client network may be implemented entirely in hardware or in a combination of hardware circuitry and software.

The computing device 600 includes a power supply 616, which may include or be connected to one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.
Clause 1. A method of identifying a root cause of an anomaly in one or more distributed computing workflows, the method comprising: accessing computing metrics of features of the one or more distributed computing workflows, at least one of the computing metrics indicating the anomaly in the one or more distributed computing workflows; representing each feature of the features as a node in a causal graph and causal relationships between features as direct links between causing nodes and resulting nodes, wherein a root node of the causal graph corresponds to the anomaly, the causal graph having multiple causal subgraphs; for each feature in each causal subgraph of the multiple causal subgraphs, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and determining a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph; for the adjacent subgraph of the multiple causal subgraphs, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores; and identifying a root cause feature of the features of the causal graph contributing to the anomaly, the identified root cause feature having a determined non-adjacent root cause score that satisfies a root cause condition.
Clause 2. The method of clause 1, wherein the root cause condition is a threshold root cause score and wherein satisfying the root cause condition includes exceeding the threshold root cause score.
Clause 3. The method of clause 1, wherein the direct links in the causal graph are directed links that point from the resulting nodes to the causing nodes.
Clause 4. The method of clause 1, further comprising: decomposing the causal graph representing the distributed computing workflows into the multiple causal subgraphs of the causal graph by at least: splitting the causal graph into the root causal subgraph and the adjacent causal subgraph at a directed link between the shared feature and at least one of the unique features; and adding, to the root causal graph, the shared feature to the directed link from which the adjacent causal graph was split from the causal graph.
Clause 5. The method of clause 1, wherein the adjacent root cause contribution scores of the unique features are modified based on the non-adjacent root cause contribution score of the shared feature and a scaling factor.
Clause 6. The method of clause 1, wherein the computing metrics include, for each feature of the features, a corresponding total processing duration.
Clause 7. The method of clause 1, further comprising triggering an analysis of the determined root cause feature and communicating the analysis to a client computing device.
Clause 8. The method of clause 1, wherein determining the non-adjacent root cause contribution score for each feature of the nodes in the causal graph to the anomaly further comprises: for a subsequent adjacent subgraph of the multiple causal subgraphs that includes subsequent unique features that are not in the root causal subgraph and are not in the adjacent causal subgraph and a subsequent shared feature that is also in the adjacent causal subgraph, modifying the adjacent root cause contribution scores of the subsequent unique features based on the non-adjacent root cause contribution score of the subsequent shared feature.
Clause 9. One or more tangible processor-readable storage media embodied with instructions for executing on one or more processors and circuits of a computing device a process for identifying a root cause of an anomaly in a distributed computing workflows, the process comprising: accessing computing metrics of features of the one or more distributed computing workflows, at least one of the computing metrics indicating the anomaly in the one or more distributed computing workflows; representing each feature of the features as a node in a causal graph and causal relationships between features as direct links between causing nodes and resulting nodes, wherein a root node of the causal graph corresponds to the anomaly, the causal graph having multiple causal subgraphs; for each feature in each causal subgraph of the multiple causal subgraphs, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and determining a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph; for the adjacent subgraph, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores; and identifying a root cause feature of the features of the causal graph contributing to the anomaly, the identified root cause feature having a determined non-adjacent root cause score that satisfies a root cause condition
Clause 10. The one or more tangible processor-readable storage media of clause 9, wherein the direct links in the causal graph are directed links that point from the resulting nodes to the causing nodes.
Clause 11. The one or more tangible processor-readable storage media of clause 9, the process further comprising decomposing the causal graph representing the distributed computing workflows into the multiple causal subgraphs of the causal graph by at least: splitting the causal graph into the root causal subgraph and the adjacent causal subgraph at a directed link between the shared feature and at least one of the unique features; and adding, to the root causal graph, the shared feature to the directed link from which the adjacent causal graph was split from the causal graph.
Clause 12. The one or more tangible processor-readable storage media of clause 9, wherein the computing metrics include, for each feature of the features, a corresponding total processing duration.
Clause 13. The one or more tangible processor-readable storage media of clause 9, wherein the computing metrics include, for each feature of the features, a corresponding usage of memory.
Clause 14. The one or more tangible processor-readable storage media of clause 9, the process further comprising triggering an analysis of the determined root cause feature.
Clause 15. A computing system for identifying a root cause of an anomaly in a distributed computing workflows, the computing system comprising: one or more hardware processors; an anomaly detector executable by the one or more hardware processors and configured to access computing metrics of features of the one or more distributed computing workflows, at least one of the computing metrics indicating the anomaly in the one or more distributed computing workflows; a causal graph generator executable by the one or more hardware processors and configured to retrieve a causal graph representing each feature as a node in the causal graph and causal relationships between features as direct links between causing nodes and resulting nodes, wherein a root node of the causal graph corresponds to the anomaly, the causal graph having multiple subgraphs; a contributions calculator executable by the one or more hardware processors and configured to compute for each feature in each causal subgraph of the multiple causal subgraphs, an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and a causal analyzer executable by the one or more hardware processors and configured to determine a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph; for the adjacent subgraph, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores, the causal analyzer further configured to identify a root cause feature of the features of the causal graph contributing to the anomaly, the identified root cause feature having a determined non-adjacent root cause score that satisfies a root cause condition
Clause 16. The computing system of clause 15, wherein the direct links in the causal graph are directed links that point from the resulting nodes to the causing nodes.
Clause 17. The computing system of clause 15, the computing system further comprising a causal graph decomposer executable by the one or more hardware processors and configured to decompose the causal graph representing the distributed computing workflows into the multiple causal subgraphs of the causal graph by at least: splitting the causal graph into the root causal subgraph and the adjacent causal subgraph at a directed link between the shared feature and at least one of the unique features; and adding, to the root causal graph, the shared feature to the directed link from which the adjacent causal graph was split from the causal graph.
Clause 18. The computing system of clause 15, wherein the computing metrics include, for each feature of the features, a corresponding total processing duration.
Clause 19. The computing system of clause 15, wherein the computing metrics include, for each feature of the features, a corresponding usage of memory.
Clause 20. The computing system of clause 15, wherein the contribution score calculator is further configured to: modify, for a subsequent adjacent subgraph of the multiple causal subgraphs that includes subsequent unique features that are not in the root causal subgraph and are not in the adjacent causal subgraph and a subsequent shared feature that is also in the adjacent causal subgraph, the adjacent root cause contribution scores of the subsequent unique features based on the non-adjacent root cause contribution score of the subsequent shared feature.
Clause 21. A system of identifying a root cause of an anomaly in one or more distributed computing workflows, the system comprising: means for accessing computing metrics of features of the one or more distributed computing workflows, at least one of the computing metrics indicating the anomaly in the one or more distributed computing workflows; means for representing each feature of the features as a node in a causal graph and causal relationships between features as direct links between causing nodes and resulting nodes, wherein a root node of the causal graph corresponds to the anomaly, the causal graph having multiple causal subgraphs; for each feature in each causal subgraph of the multiple causal subgraphs, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and means for determining a non-adjacent root cause contribution score for each feature of the nodes in the causal graph to the anomaly by at least: assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph; for the adjacent subgraph of the multiple causal subgraphs, modifying the adjacent root cause contribution scores of the unique features based on the non-adjacent root cause contribution score of the shared feature; and assigning the modified adjacent root cause contribution scores of the unique features to the corresponding features in the causal graph as non-adjacent root cause contribution scores; and identifying a root cause feature of the features of the causal graph contributing to the anomaly, the identified root cause feature having a determined non-adjacent root cause score that satisfies a root cause condition.
Clause 22. The system of clause 21, wherein the root cause condition is a threshold root cause score and wherein satisfying the root cause condition includes exceeding the threshold root cause score.
Clause 23. The system of clause 21, wherein the direct links in the causal graph are directed links that point from the resulting nodes to the causing nodes.
Clause 24. The system of clause 21, further comprising: means for decomposing the causal graph representing the distributed computing workflows into the multiple causal subgraphs of the causal graph by at least: splitting the causal graph into the root causal subgraph and the adjacent causal subgraph at a directed link between the shared feature and at least one of the unique features; and adding, to the root causal graph, the shared feature to the directed link from which the adjacent causal graph was split from the causal graph.
Clause 25. The system of clause 21, wherein the adjacent root cause contribution scores of the unique features are modified based on the non-adjacent root cause contribution score of the shared feature and a scaling factor.
Clause 26. The system of clause 21, wherein the computing metrics include, for each feature of the features, a corresponding total processing duration.
Clause 27. The system of clause 21, further comprising means for triggering an analysis of the determined root cause feature and communicating the analysis to a client computing device.
Clause 28. The system of clause 21, wherein the means for determining the non-adjacent root cause contribution score for each feature of the nodes in the causal graph to the anomaly further comprises: means for modifying for a subsequent adjacent subgraph of the multiple causal subgraphs that includes subsequent unique features that are not in the root causal subgraph and are not in the adjacent causal subgraph and a subsequent shared feature that is also in the adjacent causal subgraph, the adjacent root cause contribution scores of the subsequent unique features based on the non-adjacent root cause contribution score of the subsequent shared feature.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of identifying a root cause of an anomaly in one or more distributed computing workflows, the method comprising:
accessing computing metrics of features of the one or more distributed computing workflows, at least one of the computing metrics indicating the anomaly in the one or more distributed computing workflows;
recording each feature of the features as a node in a causal graph and causal relationships between features as direct links between causing nodes and resulting nodes, wherein a root node of the causal graph corresponds to the anomaly, the causal graph having multiple causal subgraphs;
for each feature in each causal subgraph of the multiple causal subgraphs, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and
determining a non-adjacent root cause contribution score for each feature of the nodes in the causal graph to the anomaly by at least:
assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph;
for the adjacent subgraph of the multiple causal subgraphs, modifying the adjacent root cause contribution scores of the unique features based on the non-adjacent root cause contribution score of the shared feature; and
assigning the modified adjacent root cause contribution scores of the unique features to the corresponding features in the causal graph as non-adjacent root cause contribution scores; and
identifying a root cause feature of the features of the causal graph contributing to the anomaly, the identified root cause feature having a determined non-adjacent root cause score that satisfies a root cause condition.

2. The method of claim 1, wherein the root cause condition is a threshold root cause score and wherein satisfying the root cause condition includes exceeding the threshold root cause score.

3. The method of claim 1, wherein the direct links in the causal graph are directed links that point from the resulting nodes to the causing nodes.

4. The method of claim 1, further comprising:
decomposing the causal graph representing the distributed computing workflows into the multiple causal subgraphs of the causal graph by at least:
splitting the causal graph into the root causal subgraph and the adjacent causal subgraph at a directed link between the shared feature and at least one of the unique features; and
adding, to the root causal graph, the shared feature to the directed link from which the adjacent causal graph was split from the causal graph.

5. The method of claim 1, wherein the adjacent root cause contribution scores of the unique features are modified based on the non-adjacent root cause contribution score of the shared feature and a scaling factor.

6. The method of claim 1, wherein the computing metrics include, for each feature of the features, a corresponding total processing duration.

7. The method of claim 1, further comprising triggering an analysis of the determined root cause feature and communicating the analysis to a client computing device.

8. The method of claim 1, wherein determining the non-adjacent root cause contribution score for each feature of the nodes in the causal graph to the anomaly further comprises:
for a subsequent adjacent subgraph of the multiple causal subgraphs that includes subsequent unique features that are not in the root causal subgraph and are not in the adjacent causal subgraph and a subsequent shared feature that is also in the adjacent causal subgraph, modifying the adjacent root cause contribution scores of the subsequent unique features based on the non-adjacent root cause contribution score of the subsequent shared feature.

9. One or more tangible processor-readable storage media embodied with instructions for executing on one or more processors and circuits of a computing device a process for identifying a root cause of an anomaly in a distributed computing workflows, the process comprising:
accessing computing metrics of features of the one or more distributed computing workflows, at least one of the computing metrics indicating the anomaly in the one or more distributed computing workflows;
recording each feature of the features as a node in a causal graph and causal relationships between features as direct links between causing nodes and resulting nodes, wherein a root node of the causal graph corresponds to the anomaly, the causal graph having multiple causal subgraphs;
for each feature in each causal subgraph of the multiple causal subgraphs, computing an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and
determining a non-adjacent root cause contribution score for each feature of the nodes in the causal graph to the anomaly by at least:
assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph;
for the adjacent subgraph, modifying the adjacent root cause contribution scores of the unique features based on the non-adjacent root cause contribution score of the shared feature; and
assigning the modified adjacent root cause contribution scores of the unique features to the corresponding features in the causal graph as non-adjacent root cause contribution scores; and
identifying a root cause feature of the features of the causal graph contributing to the anomaly, the identified root cause feature having a determined non-adjacent root cause score that satisfies a root cause condition.

10. The one or more tangible processor-readable storage media of claim 9, wherein the direct links in the causal graph are directed links that point from the resulting nodes to the causing nodes.

11. The one or more tangible processor-readable storage media of claim 9, the process further comprising decomposing the causal graph representing the distributed computing workflows into the multiple causal subgraphs of the causal graph by at least:
splitting the causal graph into the root causal subgraph and the adjacent causal subgraph at a directed link between the shared feature and at least one of the unique features; and
adding, to the root causal graph, the shared feature to the directed link from which the adjacent causal graph was split from the causal graph.

12. The one or more tangible processor-readable storage media of claim 9, wherein the computing metrics include, for each feature of the features, a corresponding total processing duration.

13. The one or more tangible processor-readable storage media of claim 9, wherein the computing metrics include, for each feature of the features, a corresponding usage of memory.

14. The one or more tangible processor-readable storage media of claim 9, the process further comprising triggering an analysis of the determined root cause feature.

15. A computing system for identifying a root cause of an anomaly in a distributed computing workflows, the computing system comprising:
one or more hardware processors;
an anomaly detector executable by the one or more hardware processors and configured to access computing metrics of features of the one or more distributed computing workflows, at least one of the computing metrics indicating the anomaly in the one or more distributed computing workflows;
a causal graph generator executable by the one or more hardware processors and configured to retrieve a causal graph recording each feature as a node in the causal graph and causal relationships between features as direct links between causing nodes and resulting nodes, wherein a root node of the causal graph corresponds to the anomaly, the causal graph having multiple subgraphs;
a contributions calculator executable by the one or more hardware processors and configured to compute for each feature in each causal subgraph of the multiple causal subgraphs, an adjacent root cause contribution scores corresponding to each link in the causal subgraph for which the feature is a causing node, based on the computing metrics for the one or more distributed computing workflows, each of the multiple causal subgraphs having a respective subset of the nodes and of the direct links of the causal subgraph; and
a causal analyzer executable by the one or more hardware processors and configured to determine a non-adjacent root cause contribution score for each feature of the nodes in the causal graph to the anomaly by at least:
assigning the adjacent root cause contribution scores of features in a root causal subgraph of the multiple causal subgraphs that includes the root node to the corresponding features in the causal graph as non-adjacent cause contribution scores, wherein the root causal subgraph includes a shared feature that is in an adjacent causal subgraph of the multiple causal subgraphs, wherein the adjacent causal subgraph includes unique features that are not in the root causal subgraph;
for the adjacent subgraph, modifying the adjacent root cause contribution scores of the unique features based on the non-adjacent root cause contribution score of the shared feature; and
assigning the modified adjacent root cause contribution scores of the unique features to the corresponding features in the causal graph as non-adjacent root cause contribution scores,
the causal analyzer further configured to identify a root cause feature of the features of the causal graph contributing to the anomaly, the identified root cause feature having a determined non-adjacent root cause score that satisfies a root cause condition.

16. The computing system of claim 15, wherein the direct links in the causal graph are directed links that point from the resulting nodes to the causing nodes.

17. The computing system of claim 15, the computing system further comprising a causal graph decomposer executable by the one or more hardware processors and configured to decompose the causal graph representing the distributed computing workflows into the multiple causal subgraphs of the causal graph by at least:
splitting the causal graph into the root causal subgraph and the adjacent causal subgraph at a directed link between the shared feature and at least one of the unique features; and
adding, to the root causal graph, the shared feature to the directed link from which the adjacent causal graph was split from the causal graph.

18. The computing system of claim 15, wherein the computing metrics include, for each feature of the features, a corresponding total processing duration.

19. The computing system of claim 15, wherein the computing metrics include, for each feature of the features, a corresponding usage of memory.

20. The computing system of claim 15, wherein the contribution score calculator is further configured to:
modify, for a subsequent adjacent subgraph of the multiple causal subgraphs that includes subsequent unique features that are not in the root causal subgraph and are not in the adjacent causal subgraph and a subsequent shared feature that is also in the adjacent causal subgraph, the adjacent root cause contribution scores of the subsequent unique features based on the non-adjacent root cause contribution score of the subsequent shared feature.
